(19) United States
(12) Patent Application Publication
(10) Pub. No.: US 2008/0055296 A1
(43) Pub. Date: Mar. 6, 2008

(54) ELECTRO-OPTICAL DEVICE, METHOD OF DRIVING THE SAME, AND ELECTRONIC APPARATUS

(75) Inventor: Takao Miyazawa, Shimosuwa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/832,233

(22) Filed: Aug. 1, 2007

(30) Foreign Application Priority Data
Sep. 4, 2006 (JP) 2006-238617

(51) Int. Cl. G09G 5/00; G09G 3/36

(52) U.S. Cl. 345/205; 345/82

(57) ABSTRACT

Provided herein is an electro-optical device including electro-optical elements whose gradation levels are controlled according to driving signals; and a driving circuit which generates the driving signals in which unit pulses, each having a pulse width including a basic period having a predetermined time length and a correction period having a time length which varies according to a correction value of the corresponding electro-optical element, are arranged in a number according to each of gradation values specified by the electro-optical elements.

### BACKGROUND

1. Technical Field

The present invention relates to a technology for driving an electro-optical device such as a light emitting diode.

2. Related Art

In an electro-optical device in which a plurality of electro-optical elements are arranged, gradation unevenness may occur due to characteristic error (difference with a design value or unevenness between elements) of the electro-optical elements or active elements used for driving the electro-optical elements. In order to solve this problem, a variety of technologies for correcting driving signals supplied to electro-optical devices on the basis of correction values according to characteristics thereof have been disclosed (For example, JP-A-2U05-A18696). For example, as shown in FIG. 13, in a unit period T0 (for example, a horizontal period), a driving signal including a period A having a time length according to a gradation value specified for an electro-optical device and a period B having a time period according to a correction value of the electro-optical device as a pulse width is generated for driving the electro-optical device.

However, in the configuration for generating the driving signal shown in FIG. 13, the gradation value and the correction value are simultaneously supplied to the electro-optical device in every unit period To for driving the electro-optical device. Accordingly, the number of wirings for transmitting data to the electro-optical device is increased.

### SUMMARY

An advantage of some aspects of the invention is that it reduces the amount of data required to be transmitted to an electro-optical device.

According to an aspect of the invention, there is provided an electro-optical device including electro-optical elements whose gradation levels are controlled according to driving signals; and a driving circuit which generates the driving signals in which unit pulses, each having a pulse width including a basic period having a predetermined time length and a correction period having a time length which varies according to a correction value of the corresponding electro-optical element, are arranged in a number according to each of gradation values specified by the electro-optical elements. In this aspect, since the driving signals in which the unit pulses of the number of the gradation values with the pulse width including the base period and the correction period, it is possible to employ a variety of configurations capable of reducing the amount of data to be simultaneously transmitted to the electro-optical device.

The driving circuit may include a holding circuit (for example, the latch circuit 33 shown in FIG. 6) which holds the correction values supplied in a setting period; an acquiring circuit (for example, the latch circuit 35 shown in FIG. 6) which acquires the gradation values in every unit period for outputting one gradation after the lapse of the setting period; and a signal generation circuit which generates the driving signals in which the unit pulses, each having the pulse width including the basic period and the correction period having the time length according to the correction value held by the holding circuit, are arranged in the unit period in a number according to the gradation values acquired by the acquiring circuit. According to this configuration, since the correction values are held in the holding circuit in the setting period, the correction values does not need to be transmitted to the driving circuit while the electro-optical elements are driven. Accordingly, it is possible to reduce the amount of data to be transmitted to the electro-optical device, compared with the configuration in which the correction values and the gradation values are transmitted to the driving circuit in every unit period. The detailed example of this configuration will be described later as a first embodiment.

The driving circuit may include an acquiring circuit (for example, the latch circuit 33 shown in FIG. 3) V which acquires the correction values in a plurality of sub-periods obtained by dividing a unit period for outputting one gradation; and a signal generation circuit which sets the pulse width of the unit pulses to zero if each of the correction values acquired by the acquiring circuit is a predetermined value, and generates the unit pulses including the basic period and the correction period having the time length according to the correction value in every sub-period if each of the correction values acquired by the acquiring circuit is a value other than the predetermined value. According to this configuration, since the existence of the unit pulse in each sub-period is controlled according the correction value, the gradation value does not need to be transmitted to the driving circuit. Accordingly, it is possible to reduce the amount of data to be transmitted to the electro-optical device, compared with the configuration in which the correction values and the gradation values are transmitted to the driving circuit in every unit period. The detailed example of this configuration will be described later as a second embodiment.

The driving circuit may include a holding circuit which holds the correction values supplied in a setting period; an acquiring circuit which sequentially acquires pulse arrangement information for specifying existence of the unit pulse in a plurality of sub-periods obtained by dividing a unit period for outputting one gradation after the lapse of the setting period; and a signal generation circuit which generates the driving signals in which the unit pulses, each having the pulse width including the basic period and the correction period having the time length according to the correction value held by the holding circuit, are arranged in the sub-periods specified by the pulse arrangement Information acquired by the acquiring circuit among the plurality of sub-periods. According to this configuration, since the correction values are held in the holding circuit in the setting period, the amount of data to be transmitted to the electro-optical device can be reduced. In addition, the pulse arrangement information supplied to driving circuit in every sub-period specifies the existence of the unit pulse (For example, 1-bit data is required). The detailed example of this configuration will be described later as a third embodiment.

The driving circuit may generate the driving signals in which the plurality of unit pulses are arranged such that adjacent unit pulses are continuous with each other. According to this configuration, since the number of time of change of the levels (current values or the voltage values) of the driving signals are reduced, it is possible to suppress distortion of the waveforms of the driving signals. In addition, it is possible to reduce noise due to the change of the driving signals.

The above-described electro-optical device is used in a variety of electronic apparatuses. A typical example of the electronic apparatus according to the invention is an electrophotographic image forming apparatus having the above-described electro-optical device used in the exposure of an image carrier such as a photosensitive drum. This image forming apparatus includes an image carrier on which a latent image is formed by exposure, the electro-optical device according to the invention for exposing the image carrier, and a developer for forming an image by adhering a development agent (for example, a toner) to the latent image of the image carrier. The use of the electro-optical device according to the invention is not limited to the exposure of the image carrier. For example, in an image reading apparatus such as a scanner, the electro-optical device according to the invention can be used in the illumination of an original material. This image reading apparatus includes the above-described electro-optical device and a light-receiving device (for example, a light-receiving element such as a charge coupled device (CCD) for converting the light reflected from a read target (original material) into an electrical signal. The electro-optical device in which electro-optical elements are arranged in a matrix is also used as a display device of a variety of electronic apparatuses such as a personal computer or a mobile telephone.

The invention is also specified by a method of controlling gradations of electro-optical elements according to driving signals in the above-described electro-optical device. The method may include generating the driving signals in which unit pulses, each having a pulse width including a basic period having a predetermined time length and a correction period having a time length which varies according to a corresponding correction value of the electro-optical element, are arranged in the number according to gradation values specified by the electro-optical elements. According to this method, the same operation and effect as the electro-optical device according to the invention are obtained.

The method may further include writing the correction values in a holding circuit (for example, the latch circuit 33 shown in FIG. 6) of the electro-optical device in a setting period; supplying the gradation values to electro-optical device in every unit period for outputting one gradation after the lapse of the setting period; and generating the driving signals in which the unit pulses, each having the pulse width including the basic period and the correction period having the time length which varies according to the correction value written in the holding circuit, are arranged in the unit period in the number according to the supplied gradation values.

The method may further include supplying the correction values to the electro-optical device in a plurality of sub-periods obtained by dividing a unit period for outputting one gradation; and setting the pulse width of the unit pulse to zero if the supplied correction value is a predetermined value, and generating the unit pulse including the basic period and the correction period having the time length according to the correction value in every sub-period if the supplied correction value is a value other than the predetermined value.

The method may further include writing the correction values in a holding circuit of the electro-optical device in a setting period; supplying pulse arrangement information for specifying existence of the unit pulse in a plurality of sub-periods obtained by dividing a unit period for outputting one gradation after the lapse of the setting period; and generating the driving signals in which the unit pulses, each having the pulse width including the basic period and the correction period having the time length which varies according to the correction value written in the holding circuit, are arranged in the sub-periods specified by the supplied pulse arrangement information among the plurality of sub-periods.

The invention is also specified by a driving circuit used in the electro-optical device. The driving circuit according to the invention controls gradations of electro-optical elements by the output of driving signals and includes a signal generation circuit which generates the driving signals in which unit pulses each having a pulse width including a basic period having a predetermined time length and a correction period having a time length which varies according to each of correction values of the electro-optical elements are arranged by the number according to each of gradation values specified by the electro-optical elements. By this configuration, the same operation and effect of the electro-optical device according to the invention are obtained.

### BRIEF DESCRIPTION OF THE DRAWINGS

The invention will be described with reference to the accompanying drawings, wherein like numbers reference like elements.

FIG. 1 is a block diagram showing the configuration of an electro-optical device according to a first embodiment of the invention.

FIG. 2 is a timing chart showing the waveform of a driving signal for each gradation value.

FIG. 3 is a timing chart showing the waveform of a unit pulse for each correction value.

FIG. 4 is a timing chart showing an operation of a control signal in a setting period.

FIG. 5 is a timing chart showing an operation of the control signal in a driving period.

FIG. 6 is a block diagram showing the configuration of a unit circuit.

FIG. 7 is a block diagram showing the configuration of a pulse control circuit.

FIG. 8 is a timing chart showing an operation of a control circuit according to a second embodiment of the invention.

FIG. 9 is a block diagram showing the configuration of a unit circuit.

FIG. 10 is a block diagram showing the configuration of a pulse control circuit according to a third embodiment of the invention.

FIG. 11 is a timing chart showing the waveform of a driving signal according to a modified example.

FIG. 12 is a cross-sectional view showing an example (image forming apparatus) of an electronic apparatus.

FIG. 13 is a timing chart showing the waveform of a driving signal in a known configuration.

### DESCRIPTION OF EXEMPLARY EMBODIMENTS

### A: First Embodiment

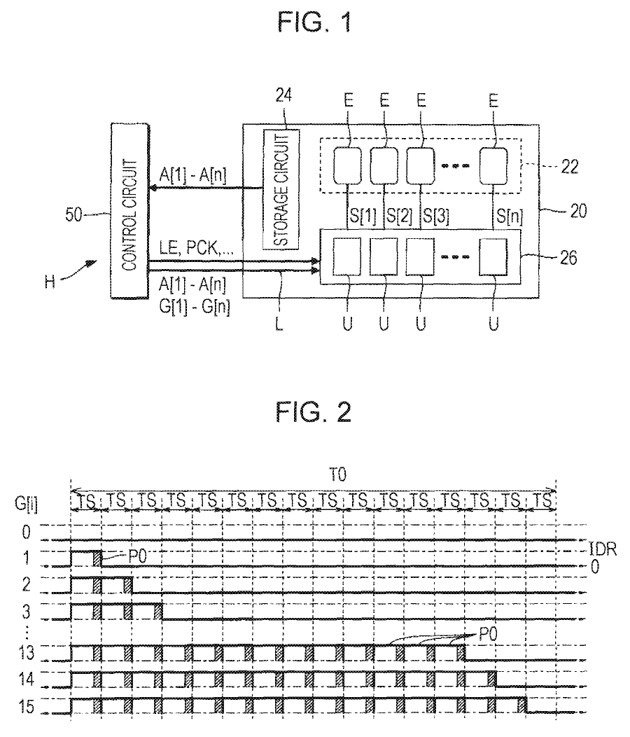

FIG. 1 is a block diagram showing a configuration of an electro-optical device according to a first embodiment of the invention. The electro-optical device H is used in an electrophotographic image forming apparatus as an exposure device (line head) for exposing a photosensitive drum. As shown in FIG. 1, the electro-optical device H includes a head module 20 for irradiating a light beam onto the photosensitive drum according to a desired image to be formed and a control circuit 50 for controlling an operation of the head module 20. The head module 20 and the control circuit 50 are, for example, electrically connected to each other via a flexible wiring substrate (not shown).

As shown in FIG. 1, the head module 20 includes an element unit 22, a storage circuit 24 and a driving circuit 26. The element unit 22 includes n (n is a positive integer) electro-optical elements E which are linearly arranged in a main scanning direction. The electro-optical elements E are organic light-emitting diodes in which a light-emitting layer formed of an electroluminescence material is interposed between an anode and cathode facing each other. The electro-optical elements E according to the present embodiment emit light by the supply of driving current IDR. By irradiating light from the electro-optical elements E, a desired latent image is formed on the surface of the photosensitive drum. The plurality of electro-optical elements may be arranged in plural rows (for example, two rows or a zigzag shape).

The storage circuit 24 is a device for storing correction values A[1] to A[n] with respect to the n electro-optical elements E configuring the element unit 22. A non-volatile memory such as an electrically erasable programmable read-only memory (EEPROM) is used as the storage circuit 24. The correction value A[i] where i is an integer satisfying 1≦i≦n) is 4-bit data for specifying a degree for correcting the light intensity of an i^{th} electro-optical element E (electric energy applied to the electro-optical device E). The correction values A[1] to A[n] are set in advance according to the characteristics of the electro-optical elements E or elements (for example, active elements or wirings) used for driving the electro-optical elements such that the actual light intensities of the n electro-optical elements E when an identical gradation value is specified become close to a predetermined value (ideally, are equalized to a predetermined value). Then power is supplied to the electro-optical device H, the correction values A[1] to A[n] are read from the storage circuit 24 and are supplied to the control circuit 50.

The control circuit 50 generates and outputs a variety of signals (for example, a light-emission permission pulse LE or a pulse control clock PCK) for defining the operation of the head module 20 to the driving circuit 26. The control circuit 50 sequentially outputs the correction values A[1] to A[n] read from the storage circuit 24 or gradation values G[1] to G[n] supplied from a variety of upper-level devices including a CPU and so on of an image forming apparatus to the head module 20. The gradation value G[i] is 4-bit data for specifying the gradation (light intensity) of the i^{th} electro-optical element E.

The driving circuit 26 drives the electro-optical elements E under the control of the control circuit 50. The driving circuit 26 may include one or a plurality of IC chips or a plurality of active elements (for example, thin-film transistors, in each of which a semiconductor layer is formed of low-temperature polysilicon), formed on the surface of a substrate together with the electro-optical elements E. As shown in FIG. 1 the driving circuit 26 includes n unit circuits U respectively corresponding to electro-optical elements. An i^{th} unit circuit U outputs a driving signal S[i] to the i^{th} electro-optical element E.

FIG. 2 is a timing chart snowing the waveform of a driving signal S[i] each gradation value G[i] specified for a corresponding electro-optical element E. As shown in FIG. 2, a period, which is a unit (Which is a unit for determining the gradation of a pixel configuring an image) for controlling the light intensity of each electro-optical element E, (hereinafter, referred to as a unit period) T0 is divided into 16 sub-periods TS. The driving signal S[i] is a current signal in which unit pulses P0 of the number according to the gradation value G[i] specified for the i^{th} electro-optical element E are arranged in the unit period (horizontal period) T0 along a time axis. In the driving signal S[i], a current value of a period excluding the unit pulse P0 becomes zero.

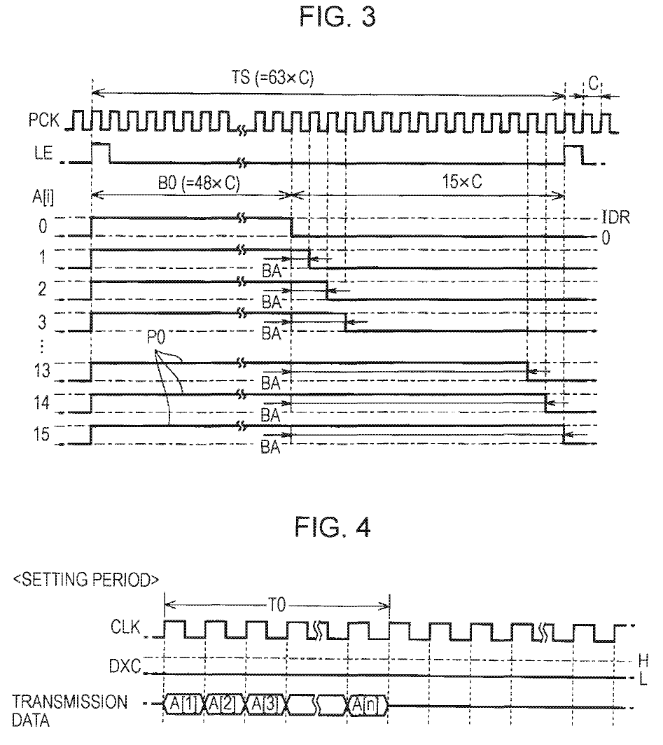

FIG. 3 is a timing chart showing the waveform of the unit pulse P0 in one sub-period TS, for each correction value A[i] specified for each electro-optical element E. As shorten in FIG. 3, the unit pulse P0 holds driving current IDR over a pulse width Including a basic period B0 and a correction period BA which are continuous with each other. The basic period B0 is a period in which a time length is fixedly set regardless of the gradation value G[i] or the correction value A[i]. In contrast, the correction period BA is a period in which a time length is controlled according to the correction value A[1]. That is, a time point of a falling edge of the unit pulse P0 varies in a range from an end point of the basic period B0 to an end point of the sub-period TS (a hatched range in FIG. 2).

The control circuit 50 shown in FIG. 1 generates and outputs the light-emission permission pulse LE and the pulse control clock PCK to the driving circuit 26. As shown in FIG. 3, the light-emission permission pulse LE is a pulse signal rising at a time point of each sub period TS. The pulse control clock PCK is a clock signal which repeatedly varies in a predetermined cycle C. The basic period B0 is set to a time length corresponding to 48 cycles C of the pulse control clock PCK. The correction period BA is set to a time length (any one of 0 to 15C) according to the correction value A[i] when one cycle C of the pulse control clock PCK is a unit (step size).

Each of the correction values A[1] to A[n] is set to become a value as large as the correction value A[i] of the electro-optical element E having a small actual light intensity (that is, such that the pulse width of the unit pulse P0 is expanded, when the n electro-optical elements E are specified with the same gradation values G[1] to G[n] and are driven at the time of non-correction (when correction values A[1] to A[n] are set to an identical value). For example, the correction value A[i] of the electro-optical element E of which the light intensity becomes a minimum at the time of the non-correction, is set to a value as small as the correction value A[i] of the electro-optical element E having a large light intensity at the time of the non-correction such that the light intensities of the electro-optical elements E after the correction using the correction values A[1] to A[n] are equalized after setting a value ‘15’ for specifying 15 cycles C to the correction, period BA.

In order to suppress unevenness of the light intensities of the electro-optical elements E with high precision, it is necessary to adjust the pulse width of the unit pulse P0 by a fine interval width of about ±2%. In the present embodiment, since the pulse width of the unit pulse P0 is adjusted by a cycle (C) obtained by dividing the sub-period TS corresponding to a maximum pulse width of the unit pulse P0 into 63 potions, the electric energy supplied to the electro-optical element E is adjusted by 1.5625% ( 1/64). Accordingly, the unevenness of the light intensities of the electro-optical elements E can be corrected with high precision.

Next, transmission of data (the correction value A[i] and the gradation value G[i]) on the driving circuit 26 from the control circuit 50 and the detailed configuration for generating the driving signal S[i] will be described. FIG. 4 is a timing chart explaining the operation of the control circuit 50 in a predetermined period (hereinafter, referred to as a setting period) immediately after power is supplied. As shown in FIG. 4, the control circuit 50 sequentially outputs the correction values A[1] to A[n] to the driving circuit 26 in synchronization with the clock CLK in each unit period T0 of the setting period.

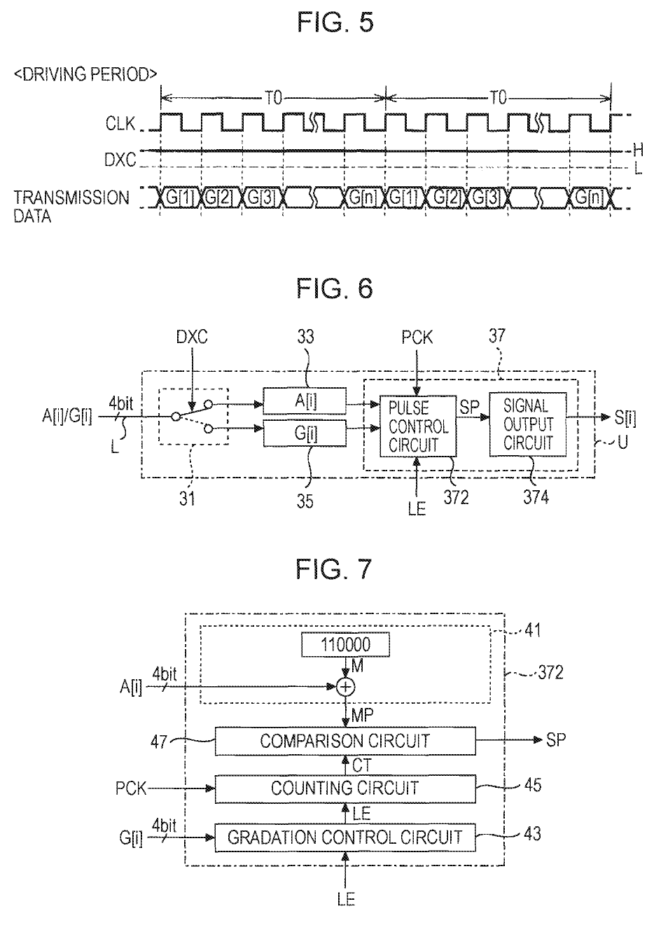

FIG. 5 is a timing chart explaining the operation of the control circuit 50 in a period (hereinafter, referred to as a driving period) in which the electro-optical elements E are actually driven after the lapse of the setting period. As shown in FIG. 5, the control circuit 50 sequentially outputs the gradation values G[1] to G[n] to the driving circuit 26 in synchronization with the clock CLK in each unit period T0 of the driving period. As shown in FIGS. 4 and 5, the control circuit 50 outputs a control signal DXC for holding a low level in the setting period and holding a high level in the driving period to the driving circuit. The gradation values G[1] to G[n] or the correction values A[1] to A[n] may be transmitted for a period shorter than the unit period T0.

FIG. 6 is a block diagram showing the detailed configuration of one unit circuit U configuring the driving circuit 26. In FIG. 6, only the i^{th} unit circuit U is representatively shown. As shown in FIG. 6, the unit circuit U includes an output selector 31, latch circuits 33 and 35, and a signal generation circuit 37. As shown in FIGS. 4 and 5, the correction values A[1] to A[n] and the gradation values G[i] to G[n] output from the control circuit 50 in the respective periods are serially supplied to the unit circuit U via a common transmission line L.

The output selector 31 is a switch circuit which selectively sets a connection portion of the transmission line L (output portion of the data supplied from the control circuit 50) for the latch circuit 33 or 35 according to the control signal DXC. The output selector 31 selects the latch circuit 33 in the setting period in which the control signal DXC is at the low level and selects the latch circuit 25 in the driving period in which the control signal DXC is at the high level. The latch circuit 33 holds and outputs the correction value A[i] received from the transmission line L via the output selector 31 in the setting period. The correction value A[i] output from the latch circuit 33 is held even in the driving period after the lapse of the setting period. In contrast, the latch circuit 35 holds and outputs the gradation value G[i] supplied in the driving period for each unit period T0.

The signal generation circuit 37 is a device for generating the driving signal S[i] on the basis of the correction value A[i] held by the latch circuit 33 and the gradation value G[i] held by the latch circuit 35 and includes a pulse control circuit 372 and a signal output circuit 374. The pulse control circuit 372 generates and outputs a pulse signal SP for specifying the pulse width of the driving signal S[i]. The pulse control circuit 372 receives the light-emission permission pulse LE and the pulse control clock PCK shown in FIG. 3 from the control circuit 50.

The signal output circuit 374 shown in FIG. 6 is a device for generating the driving signal S[i] having the waveform shown in FIG. 2 on the basis of the pulse signal SP. That is, the signal output circuit 374 outputs the driving current IDR in a period in which the pulse signal P is held at the high level and stops the output of the driving current IDR in a period in which the pulse signal SP is held in the lower level.

Next, the detailed configuration of the pulse control circuit 372 will be described with reference to FIG. 7. As shown in FIG. 7, the pulse control circuit 372 includes an adding circuit 41, a gradation control circuit 43, a counting circuit 45, and a comparison circuit 47. The adding circuit 41 outputs an addition value MP obtained by adding the correction value A[i] held by the latch circuit 33 to a predetermined value M. The value M is a value for specifying the time length of the basic period B0 using the cycle C of the pulse control clock PCK as a unit. Since the basic period B0 of the present embodiment is set to the time length corresponding to 48 cycles as shown in FIG. 3, the value M becomes a binary value “11000” as shown in FIG. 7. Since the correction value A[i] specifies the time length of the correction period BA by the number of cycles C, the addition value MP output from the adding circuit 41 becomes a 6-bit value for specifying the pulse width of the unit pulse P0 by the number of cycles C. As can be seen from the above-described description, the adding circuit 41 may be a circuit which adds a value “1” to two upper bits of the correction value A[i]

The gradation control circuit 43 receives the light-emission permission pulse LE from the control circuit 50 for each sub-period TS and receives the gradation value G[i] from the latch circuit 35. The gradation control circuit 43 performs counting from a start point of the unit period T0, outputs (bypasses) the light-emission permission pulses LE of the number according to the gradation value G[i] to the counting circuit 45 and blocks residual light-emission permission pulses LE supplied in the unit period T0. The counting circuit 45 counts the pulse control clock PCK and outputs a counted value CT to the comparison circuit 47. The counted value CT is reset whenever the light-emission permission pulse LE is supplied from the gradation control circuit 43.

The comparison circuit 47 sets the level of the pulse signal SP according to the result of comparison between the added value MP output from the adding circuit 41 and the counted value CT output from the counting circuit 45. In more detail, the comparison circuit 47 holds the pulse signal SP at the high level in a period in which the counted value CT is lower than the added value MP and transitions the pulse signal SP to the low level in a time point where the counted value CT exceeds the added value MP. Accordingly, in the sub-period TS corresponding to the period of the light-emission permission pulse LE, the pulse signal SP has the pulse width according to the basic period B0 and the correction period BA according to the correction value A[i] (the same pulse width as the unit pulse P0 of the driving signal S[i]).

Since the light-emission permission pulses LE after the lapse of the sub-period TS of the number corresponding to the gradation value G[i] in the unit period T0 are blocked by the gradation control circuit 43, the counted value CT of the counting circuit 45 is not reset up to an end point of the unit period T0. Accordingly, the pulse signal SP has a waveform in which the pulses including the basic period B0 and the correction period BA are arranged in every sub-period TS by the number according to the gradation value G[i]. In the period in which the pulse signal SP is at the high level, the signal output circuit 374 outputs the driving current IDR such that the driving signal S[i] has a waveform in which the electric energy according to the gradation value G[i] and the correction value [A[i] is applied to the electro-optical elements E, as shown in FIG. 2.

As described above, in the present embodiment, since the correction values A[1] to A[n] are transmitted from the control circuit 50 to the driving circuit 26 and are held before the driving period in which the electro-optical elements E are actually driven, the transmission of the correction values A[1] to A[n] in the driving period is unnecessary. Accordingly, the bit width of the transmission line L for connecting the control circuit 50 and the head module 20 is reduced, compared with the known configuration for transmitting the correction value A[i] and the gradation value G[i] to the driving circuit 26 in every unit period T0. Since the operation speed of the driving circuit 26 is reduced, it is possible to downsize the driving circuit 26 or to reduce manufacturing cost.

### B: Second Embodiment

Next, a second embodiment of the invention will be described. The elements having the same functions or operations as the first embodiment are denoted by like reference numerals and thus the detailed description thereof will be omitted.

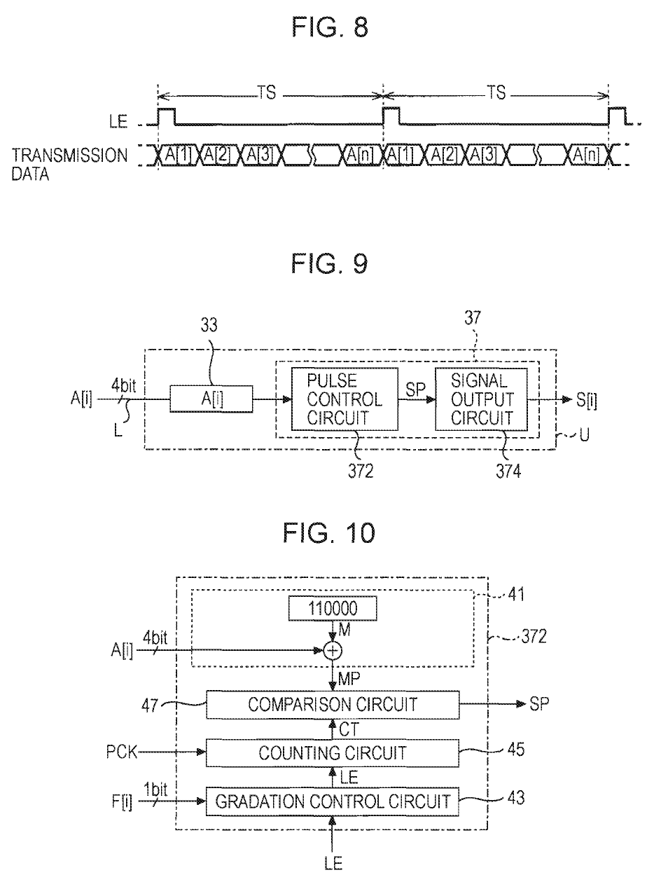

FIG. 8 is a timing chart explaining an operation of a control circuit 50. As shown in FIG. 8, the control circuit 50 outputs correction data A[1] to A[n] to a driving circuit 26 via a transmission line L in the plurality of sub-periods TS. The correction value A[i] of each sub-period TS is set according to the gradation value G[i] That is, the control circuit 50 outputs the correction value A[i] read from the storage circuit 24 in each of the sub-periods TS of the number according to the gradation value G[i] in the unit period T0 and sets the correction value A[i] to zero in the residual sub-periods TS of the unit period T0.

FIG. 9 is a block diagram showing the configuration of the i^{th} unit circuit U. The unit circuit U of the present embodiment includes a latch circuit 33 and a signal generation circuit 37. The latch circuit 33 holds and outputs the correction value A[i] supplied from the control circuit 50 through the transmission line L in every sub-period TS. The signal generation circuit 37 is a device for generating the driving signal S[i] on the basis of the correction value A[i] output from the latch circuit 33 and includes a pulse control circuit 372 and a signal output circuit 374.

The pulse control circuit 372 sets the level of the pulse signal SP in every sub-period TS according to the correction value A[i] That is, if the correction value A[i] in one sub-period TS is zero, the pulse signal SP in the sub-period TS is at the low level. If the correction value A[i] in one sub-period TS is a value other than zero, the pulse signal SP is set to the high level over the pulse width including the basic period B0 and the correction period BA having the time length according to the correction value A[i] in the sub-period TS.

The signal output circuit 374 holds the driving current IDR in a period in which the pulse signal SP is held at the high level and generates the driving signal S[i] having a current value of zero in a period in which the pulse signal SP is held at the low level. Accordingly, for example, the control circuit 50 sequentially performs counting from a start point of the unit period T0, outputs the correction value A[i] other than zero in the sub-periods TS of the number according to the gradation value G[i], and sets the correction value A[i] to zero in the residual sub-period TS such that the driving signal S[i] shown in FIG. 2 is generated.

As described above, in the present embodiment, since the existence of the unit pulse P0 in every sub-period TS is specified by the correction value A[i], the gradation values G[1] to G[n] do not need to be transmitted from the control circuit 50 to the head module 20. Accordingly, similar to the first embodiment, the bit width of the transmission line L for connecting the control circuit 50 and the head module 20 is reduced, compared with the known configuration for transmitting the correction value A[i] and the gradation value G[i] to the driving circuit 26 in every unit period T0.

In the present embodiment, since the existence of the unit pulse P0 is specified in every sub-period TS, it is possible to arbitrarily specify the light-emission patterns of the electro-optical elements E. For example, when the correction value A[i] other than zero is output in the sub-periods periods TS of the number according to the gradation value G[i] from the start point of the unit period T0, the electro-optical elements E emit light in a front period of the unit period T0 (a period including the start point of the unit period T0). When the correction value A[i] other than zero is output in the sub-periods TS just before the end point of the unit period T0 by the number according to the gradation value G[i], the electro-optical elements E emit light in the rear period of the unit period T0.

### C: Third Embodiment

Next, a third embodiment of the invention will be described. The elements having the same functions or operations as the first embodiment are denoted by like reference numerals and thus the detailed description thereof will be omitted.

The whole configuration of one unit circuit U configuring a driving circuit of the present embodiment is similar to that shown in FIG. 6. Similar to the first embodiment, the control circuit 50 transmits the correction values A[1] to A[n] to the driving circuit 26 in the setting period. The correction value A[i] is held in the latch circuit 33 of the i^{th} unit circuit U in the setting period. Each unit pulse P0 of the driving signal S[i] is set to have the pulse width according to the correction value A[i] similar to the first embodiment.

In the first embodiment, 4-bit gradation values G[1] to G[n] are transmitted to the head module 20 in every unit period T0. In contrast, in the present embodiment, pulse arrangement information F[1] to F[n] are sequentially transmitted from the control circuit 50 to the head module 20 in every sub-period TS. The pulse arrangement information F[i] is 1-bit information for specifying the existence of the unit pulse P0 in the driving signal S[i] in every sub-period TS. That is, in a sub-period TS in which the pulse arrangement information F[i] is set to “1”, the unit pulse P0 is arranged in the driving signal S[i] and, in a sub-period TS in which the pulse arrangement information F[i] is set to “0”, the current value of the driving signal S[i] becomes zero (that is, the unit pulse P0 is not arranged). The pulse arrangement information F[i] transmitted to the driving circuit 26 is held in the latch circuit 35 of the it unit circuit U.

FIG. 10 is a block diagram showing the detailed configuration of the pulse control circuit 372 according to the present embodiment. As shown in FIG. 10, the 1-bit pulse arrangement information F[i] is supplied to the gradation control circuit 43 of the pulse control circuit 372. The gradation control circuit 43 outputs the light-emission permission pulse LE to the counting circuit 45 if the pulse arrangement information F[i] is “1” and stops the output of the light-emission permission pulse LE to the counting circuit 45 if the pulse arrangement information F[i] is “0”. A logic circuit (AND gate) for performing an AND operation of the pulse arrangement information F[i] and the light-emission permission pulse LE is used as the gradation control circuit 43. The operations of the elements excluding the gradation control circuit 43 in FIG. 10 are similar to those of the first embodiment. Accordingly, the driving signal S[i] in which the unit pulse P0 having the pulse width according to the correction value A[i] is arranged in the sub-period TS specified by the pulse arrangement information F[i] in the unit period T0 is output from the in electro-optical element E.

As described above, even in the present embodiment, since the correction values A[1] to A[n] are transmitted to and held in the driving circuit before the driving period, similar to the first embodiment, the bit width of the transmission line L for connecting the control circuit 50 and the head module 20 is reduced. In the driving period, since the 1-bit pulse arrangement information F[1] is transmitted in every unit circuit U, it is possible to further reduce the bit width of the transmission line L compared with the first embodiment in which the 4-bit gradation value G[i] is transmitted to the driving circuit 26. Since a simple AND gate is employed as the gradation control circuit 43, the configuration of the pulse control circuit 372 is simplified compared with the first embodiment and the scale thereof (scale of the driving circuit 26) is reduced. Since the existence of the unit pulse P0 is specified in every sub-period TS, it is possible to arbitrarily specify the light-emission patterns of the electro-optical elements E.

### D: MODIFIED EXAMPLES

The above-described embodiments may be variously modified. The detailed modified examples are as follows. The following examples may be combined.

### (1) Modified Example 1

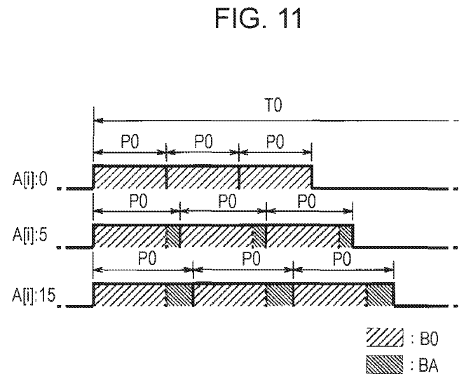

Although the unit pulses P0 are arranged at an interval in the configuration for controlling the pulse widths of the unit pulses P0 in the sub-periods obtained by dividing the unit period T0, a configuration for generating a driving signal S[i] in which a plurality of unit pulses P0 are arranged such that the adjacent unit pulses P0 are continuous with each other may be employed. For example, FIG. 11 is a timing chart showing the waveform of the driving signal S[i] according to the modified example. In FIG. 11, it is assumed that the gradation value G[i] is set to “3” (three unit pulses P0 are arranged in the unit period T0).

As shown in FIG. 11, if the correction value A[i] is a value other than zero, a basic period B0 of a next unit pulse P0 is started at an end point of a correction period BA in each unit pulse P0. If the correction value A[i] is zero, the basic period B0 of a next unit pulse P0 is started at an end point of the basic period B0 of each unit pulse P0. According to the above-described configuration, since the number of times of change of the current value of the driving signal S[i] is reduced, it is possible to suppress distortion of the waveform of the driving signal S[i] and to supply desired electric energy to the electro-optical elements E with high precision. In addition, it is possible to reduce noise due to the change of the current value of the driving signal S[i].

### (2) Modified Example 2

Although the correction values A[1] to A[n] are stored in the storage circuit 24 in the above-described embodiments, a value for directly specifying the time length of the correction period BA of the unit pulse P0 does not need to be necessarily in the storage circuit 24. For example, a configuration for allowing the control circuit 50 to perform a predetermined operation with respect to values of the electro-optical elements E stored in the storage circuit 24 to calculate the correction values A[1] to A[n] may be employed.

### (3) Modified Example 3

The organic light-emitting diode is only an example of the electro-optical device. The electro-optical device according to the invention may be a self-emission type device, a non-light-emitting type device (for example, a liquid crystal device) for varying transmissivity of external light, a current driving type device which is driven by supplying current, or a voltage driving type device which is driven by applying a voltage. For example, a variety of electro-optical devices such as an inorganic electroluminescence device, a field-emission (FE) device, a surface-conduction electron-emitter (SE), a ballistic electron surface emitting (BS) device, a light-emitting diode (LED) device, a liquid crystal device, an electromigration device, and an electrochromic device can be used in the invention.

### E: Application Example

An example of an electronic apparatus (image forming apparatus) using the electro-optical device according to the invention will now be described.

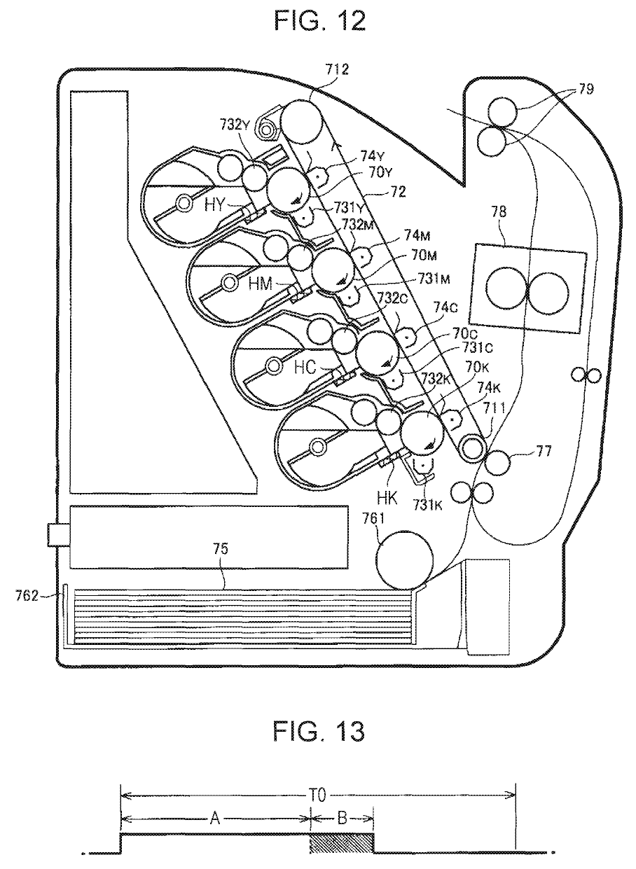

FIG. 12 is a cross-sectional view showing the configuration of the image forming apparatus using the electro-optical device H according to each of the above-described embodiments, The image forming apparatus is a tandem type full-color image forming apparatus and includes four electro-optical devices H (HK, HC, HM, and HY) according to the above-described embodiment and four photosensitive bodies 70 (70K, 70C, 70M and 70Y) corresponding to the electro-optical devices H. Each electro-optical device H faces an image forming surface (outer circumferential surface) of the photosensitive body 70 corresponding thereto. Subscripts “K”, “C”, “M” and “Y” of the reference numerals indicates that the elements are used for the development of black (K), cyan (C) magenta (M) and yellow (Y).

As shown in FIG. 12, an endless intermediate transfer belt 72 is stretched over a driving roller 711 and a driven roller 712. The four photosensitive drams 70 are arranged around the intermediate transfer belt 72 at a predetermined interval. The photosensitive drums 70 are rotated in synchronization with the driving of the intermediate transfer belt 72.

Corona chargers 731 (731K, 731C, 731M and 731M) and developers 732 (732K, 732C, 732M and 732Y) are arranged around the photosensitive drums 70, in addition to the electro-optical devices H. The corona chargers 732 uniformly, charge the image forming surfaces of the photosensitive drums 70 corresponding thereto. The charged image forming surfaces are exposed by the electro-optical devices H to form an electrostatic latent image. The developers 732 form images (visible image) on the photosensitive drums 70 by adhering a development agent (toner) to the electrostatic latent image.

The images of respective colors (black, cyan, magenta and yellow), which are formed on the photosensitive drums 70, are sequentially transferred (primary transfer) on the surface of the intermediate transfer belt 72 to form a full-color image. Four primary transfer corotrons (transfer devices) 74 (74K, 74C, 74M and 74Y) are arranged inside the intermediate transfer belt 72. The primary transfer corotrons 74 electrostatically suck the images from the photosensitive drums 70 corresponding thereto and transfer the images to the intermediate transfer belt 72 passing through a gap between the photosensitive drums 70 and the primary transfer corotrons 74

Sheet (recording medium) 75 are fed from a sheet feeding cassette 762 by a pickup roller 761 one by one and are transported to a nip between the intermediate transfer belt 72 and a secondary transfer roller 77. The full-color image formed on the surface of the intermediate transfer belt 72 is transferred (secondary transfer) onto one surface of the sheet 75 by the secondary transfer roller 77 and the sheet passes through a pair of fixing rollers such that image is fixed on the sheet 75. A pair of ejection rollers 79 ejects the sheet 75 on which the image is fixed by the above-described processes.

Since the organic light-emitting diode device is used as a light source (exposure device) in the above-described image forming apparatus, the apparatus is down-sized compared with a configuration using a laser scanning optical system. The electro-optical device H may apply to an image forming apparatus having a configuration other than the above-described configuration. For example, the electro-optical device H may be used in a rotary development type image forming apparatus, an image forming apparatus in which an image is directly transferred from a photosensitive drum onto a sheet without using an intermediate transfer belt, or an image forming apparatus for forming a monochromic image.

The use of the electro-optical device H is not limited to the exposure of an image carrier. For example, the electro-optical device H is employed in an image reading apparatus as an illumination apparatus for irradiating light onto a read target such as an original material. As this kind of image reading apparatus, there are a scanner, a reading portion of a copier or a facsimile machine, a barcode reader, and a two-dimensional image code reader for reading a two-dimensional image code such as QR code®.

The electro-optical device in which the electro-optical elements E are arranged in a matrix is used as display devices of a variety of electronic apparatuses. As the electronic apparatus according to the invention, there are a mobile personal computer, a cellular phone, a personal digital assistants (PDA), a digital camera, a television set, a video camera, a car navigation system, a pager, an electronic organizer, an electronic paper, an electronic calculator, a word processor, a workstation, a videophone, a POS terminal, a printer, a scanner, a copier, a video player, and a touch-panel-equipped device.

The entire disclosure of Japanese Patent Application No. 2006-238617, filed Sep. 4, 2006 is expressly incorporated by reference herein.

What is claimed is:

1. An electro-optical device comprising:
electro-optical elements whose gradation levels are controlled according to driving signals; and
a driving circuit which generates the driving signals in which unit pulses, each having a pulse width including a basic period having a predetermined time length and a correction period having a time length which varies according to a correction value of the corresponding electro-optical element, are arranged in a number according to each of gradation values specified by the electro-optical elements.

2. The electro-optical device according to claim 1, wherein the driving circuit includes:
a holding circuit Which holds the correction values supplied in a setting period;
an acquiring circuit which acquires the gradation values in every unit period for outputting one gradation after the lapse of the setting period; and
a signal generation circuit Which generates the driving signals in which the unit pulses, each having the pulse width including the basic period and the correction period having the time length according to the correction value held by the holding circuit, are arranged in the unit period in the number according to the gradation value acquired by the acquiring circuit.

3. The electro-optical device according to claim 1, wherein the driving circuit includes:
an acquiring circuit which acquires the correction values in a plurality of sub-periods obtained by dividing a unit period for outputting one gradation; and
a signal generation circuit which sets the pulse width of the unit pulses to zero if the correction value acquired by the acquiring circuit is a predetermined value, and generates the unit pulses including the basic period and the correction period having the time length according to each of the correction values in every sub-period if the corresponding correction value acquired by the acquiring circuit is a value other than the predetermined value.

4. The electro-optical device according to claim 1, wherein the driving circuit includes:
a holding circuit which holds the correction values supplied in a setting period;
an acquiring circuit which sequentially acquires pulse arrangement information for specifying existence of the unit pulse in a plurality of sub-periods obtained by dividing a unit period for outputting one gradation after the lapse of the setting period; and
a signal generation circuit which generates the driving signals in which the unit pulses, each having the pulse width including the basic period and the correction period having the time length according to the correction value held by the holding circuit, are arranged in the sub-periods specified by the pulse arrangement information acquired by the acquiring circuit among the plurality of sub-periods.

5. The electro-optical device according to claim 1, wherein the driving circuit generates the driving signals in which the plurality of unit pulses are arranged such that adjacent unit pulses are continuous with each other.

6. An electronic apparatus comprising the electro-optical device according to claim 1.

7. A method of driving an electro-optical device in which gradations of electro-optical elements are controlled according to driving signals, the method comprising:
generating the driving signals in which unit pulses, each having a pulse width including a basic period having a predetermined time length and a correction period having a time length which varies according to a corresponding correction value of the electro-optical element, are arranged by the number according to gradation values specified by the electro-optical elements.

8. The method according to claim 7, further comprising:
writing the correction values in a holding circuit of the electro-optical device in a setting period;
supplying the gradation values to electro-optical device in every unit period for outputting one gradation after the lapse of the setting period; and
generating the driving signals in which the unit pulses, each having the pulse width including the basic period and the correction period having the time length which varies according to the correction value written in the holding circuit, are arranged in the unit period in the number according to the supplied gradation values.

9. The method according to claim 7, further comprising:
supplying the correction values to the electro-optical device in a plurality of sub-periods obtained by dividing a unit period for outputting one gradation; and
setting the pulse width of the unit pulse to zero if the supplied correction value is a predetermined value, and generating the unit pulse including the basic period and the correction period having the time length according to the correction value in every sub-period if the supplied correction value is a value other than the predetermined value.

10. The method according to claim 7, further comprising:
writing the correction values in a holding circuit of the electro-optical device in a setting period;
supplying pulse arrangement information for specifying existence of the unit pulse in a plurality of sub-periods obtained by dividing a unit period for outputting one gradation after the lapse of the setting period; and
generating the driving signals in which the unit pulses, each having the pulse width including the basic period and the correction period having the time length which varies according to the correction value written in the holding circuit, are arranged in the sub-periods specified by the supplied pulse arrangement information among the plurality of sub-periods.

11. The method according to claim 7, wherein the driving signals in which the plurality of unit pulses are arranged such that adjacent unit pulses are continuous with each other are generated.
